(19) United States
(12) Patent Application Publication
(10) Pub. No.: US 2024/0359044 A1
(43) Pub. Date: Oct. 31, 2024

(54) PROCESSING APPARATUS FOR REMOVING DIOXIN IN FLY ASH FROM DOMESTIC WASTE INCINERATION BY USING BALL MILL

(71) Applicant: Nanjing Institute of Environmental Sciences, MEE, Nanjing (CN)

(72) Inventors: Houhu ZHANG, Nanjing (CN); Bing MA, Nanjing (CN); Hao ZHOU, Nanjing (CN); Xiaofei YAN, Nanjing (CN); Guodong KANG, Nanjing (CN); Yi WANG, Nanjing (CN)

(73) Assignee: Nanjing Institute of Environmental Sciences, MEE, Nanjing (CN)

(21) Appl. No.: 18/630,261

(22) Filed: Apr. 9, 2024

(30) Foreign Application Priority Data
Apr. 25, 2023 (CN) 202310455490.3

(51) Int. Cl. A62D 3/40; A62D 101/28; B09B 3/35; B09B 3/40; B09B 101/30

(52) U.S. Cl. CPC A62D 3/40; B09B 3/35; B09B 3/40; A62D 2101/28; B09B 2101/30

(57) ABSTRACT

A processing apparatus for removing dioxin in fly ash from domestic waste incineration by using a ball mill includes a grinder as well as a feeding body and a discharging body that are separately arranged at both ends of the grinder. In the present disclosure, an induction coil is electrified by arranging a heating body to generate an alternating magnetic field such that eddies generate on an inner wall of a grinding cylinder in the induction coil, the grinding cylinder is heated by the energy of these eddies, making a grinding ball thermally desorb and decompose a harmful component, that is, dioxin in the fly ash through a high temperature when grinding the fly ash from the domestic waste incineration since a temperature in the grinding cylinder reaches 300-500° C. during grinding.

### CROSS-REFERENCE TO RELATED APPLICATION

The application claims priority to Chinese Patent Application No. 202310455490.3, filed on Apr. 25, 2023, which is incorporated herein by reference in its entirety.

### TECHNICAL FIELD

The present disclosure relates to the technical field for processing fly ash from domestic waste incineration, and in particular to a processing apparatus for removing dioxin in fly ash from domestic waste incineration by using a ball mill.

### BACKGROUND

Fly ash from domestic waste incineration refers to components trapped on a flue gas cleaning system as well as bottom ash settled at the bottoms of a flue and a chimney. Since the fly ash from the incineration contains hazardous substances such as dioxin and heavy metals, a place where the fly ash from the domestic waste incineration is produced must be subjected to necessary stabilizing and curing treatments; and the fly ash may be transported by a special transportation tool after the stabilizing and curing treatments, transferred to a fly ash warehouse in forms of closed collection and transferring, and sent to a landfill for being landfilled after a qualified leaching toxicity test.

After the existing processing apparatus processes the fly ash from the domestic waste incineration preliminarily, an extra incinerator still needs to be equipped to thermally decompose the dioxin in the fly ash from the domestic waste incineration, which has tedious steps and a relatively low processing efficiency for the fly ash from the domestic waste incineration, and therefore a processing apparatus for removing dioxin in fly ash from domestic waste incineration by using a ball mill is proposed.

### SUMMARY

The objective of the present disclosure is to provide a processing apparatus for removing dioxin in fly ash from domestic waste incineration by using a ball mill, to solve the issue proposed in the background art.

To implement the above objective, the present disclosure aims at providing a processing apparatus for removing dioxin in fly ash from domestic waste incineration by using a ball mill, including a grinder as well as a feeding body and a discharging body that are separately arranged at both ends of the grinder, where the grinder includes a removing body and a heating body arranged on a surface of the removing body, the removing body includes a workbench and a grinding cylinder rotationally connected with both ends of a top of the workbench, a drive body is arranged on one side of one end of the workbench, meshes with a gear on a surface of the grinding cylinder, and is used for driving the grinding cylinder to rotate, the grinding cylinder is located in the heating body that is used for heating the grinding cylinder, both ends of the grinding cylinder communicate with a feeding port and a discharging port respectively, the feeding body includes a first bracket and a hopper arranged at a top of the first bracket, the first bracket is connected with one end of the workbench, the hopper communicates with one end of the feeding port that is away from the grinding cylinder, the feeding body is used for putting the fly ash from the domestic waste incineration into the grinding cylinder, a cooling body is arranged in the discharging port, the discharging body includes a second bracket connected with the other end of the workbench, a dumping tube is arranged at a top of the second bracket and communicates with one end of the cooling body that is away from the grinding cylinder, and the discharging body is used for discharging the processed fly ash from the domestic waste incineration.

As a further improvement of the technical solution, an inner cylinder is arranged in the grinding cylinder and includes a cylinder and a plurality of connecting plates arranged on an outer wall of the cylinder, the cylinder is provided with a plurality of sieve pores penetrating through inner and outer walls thereof, and the connecting plates are connected with the inner wall of the grinding cylinder.

As a further improvement of the technical solution, the heating body includes a housing and an induction coil arranged in the housing, both ends of a bottom of the housing are connected with an upper surface of the workbench, the grinding cylinder is located in the induction coil, and a shielding cover is arranged between the housing and the induction coil.

As a further improvement of the technical solution, the drive body includes a motor arranged on one side of one end of the workbench, the motor is connected with a drive gear through a coupling, one end of the outer surface of the grinding cylinder that is close to the motor is provided with a transmission gear, and the transmission gear meshes with the drive gear.

As a further improvement of the technical solution, the cooling body includes an inner tube located in the discharging port, the other end of the inner tube communicates with the dumping tube, a snap ring is arranged in a middle of a surface of the inner tube and in plugging fit with the discharging port, and one end of an outer surface of the inner tube that is away from the discharging port is provided with a plurality of fins.

As a further improvement of the technical solution, a second spiral plate is arranged in the feeding port, and a first spiral plate is arranged in the inner tube.

As a further improvement of the technical solution, a middle of one end of the second spiral plate that is away from the heating body is connected with a third spiral plate, and the third spiral plate is located at a bottom inside the hopper.

As a further improvement of the technical solution, one end of the dumping tube that is away from the heating body is provided with an air filtering port, a dumping port is arranged at a bottom of a middle of the dumping tube, a filter screen is arranged at a place in the air filtering port that is close to the dumping port, a plurality of activated carbon plates are arranged in the air filtering port, a fan is arranged closely to the outside in the air filtering port, and the activated carbon plates are located between the fan and the filter screen.

As a further improvement of the technical solution, one side of the discharging body that is close to the inner tube is provided with an extensional side, and one side of the inner tube that is close to the discharging body is partially located in the extensional side.

Compared with the prior art, the present disclosure has the following beneficial effects.

Firstly, in the processing apparatus for removing dioxin in fly ash from domestic waste incineration by using the ball mill, the induction coil is electrified by arranging the heating body to generate an alternating magnetic field such that eddies generate on the inner wall of the grinding cylinder in the induction coil, the grinding cylinder is heated by the energy of these eddies, making a grinding ball thermally desorb and decompose the harmful component, that is, dioxin in the fly ash through a high temperature when grinding the fly ash from the domestic waste incineration since the temperature in the grinding cylinder reaches 300-500° C. during grinding, thereby implementing the harmless treatment on the fly ash from the domestic waste incineration.

Secondly, in the processing apparatus for removing dioxin in fly ash from domestic waste incineration by using the ball mill, the inner cylinder is arranged such that the fly ash from the domestic waste incineration and the grinding ball rotate in the inner cylinder, when the fly ash from the domestic waste incineration is partially ground to powder through ball-milling, the powder can pass through the inner cylinder through the sieve pores and move in the space between the inner cylinder and the grinding cylinder, that is, only the fly ash from the domestic waste incineration, which is not yet ground into the powder, leaves in the inner cylinder, and the grinding ball can grind this part of fly ash from the domestic waste incineration, thus improving the processing efficiency for the fly ash from the domestic waste incineration.

Lastly, in the processing apparatus for removing dioxin in fly ash from domestic waste incineration by using the ball mill, the fan drives the air in the discharging body to flow by arranging the air filtering port, such that the air in the cooling body is discharged from the air filtering port, when the air wrapped with powder-like spills passes through the filter screen, the spills are intercepted by the filter screen, move down along the filter screen, enter the dumping port and are discharged, and when the air passes through the activated carbon plates, a trace amount of dioxin contained therein is absorbed by the activated carbon plates, thus ensuring to process the dioxin completely.

### BRIEF DESCRIPTION OF THE DRAWINGS

FIG. 1 is a schematic diagram of an overall structure of the present disclosure.

FIG. 2 is a structure schematic diagram of a grinder of the present disclosure.

FIG. 3 is a structure schematic diagram of a removing body of the present disclosure.

FIG. 4 is a section structure diagram of a grinding cylinder of the present disclosure.

FIG. 5 is a section structure diagram of a cooling body of the present disclosure.

FIG. 6 is a structure schematic diagram of a heating body of the present disclosure.

FIG. 7 is a structure schematic diagram of a feeding body of the present disclosure.

FIG. 8 is a section structure diagram of a discharging body of the present disclosure.

### DETAILED DESCRIPTION OF THE EMBODIMENTS

The technical solution in the embodiments of the present disclosure is clearly and completely elaborated below in combination with the drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

In the description of the present disclosure, it is understood that orientation or position relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, and the like are based on the orientation or position relationships as shown in the drawings, for ease of describing the present disclosure and simplifying the description only, rather than indicating or implying that the mentioned device or element necessarily has a particular orientation and must be constructed and operated in the particular orientation. Therefore, these terms should not be understood as limitations to the present disclosure.

In addition, the terms “first” and “second” are merely used for description, instead of being understood as indicating or implying relative importance or impliedly indicating the quantity of the showed technical features. Thus, the features defined with “first” and “second” may expressly or impliedly one or more features. In the description of the present disclosure, “a plurality of” means two or above two, unless specific limitation otherwise.

### Embodiment 1

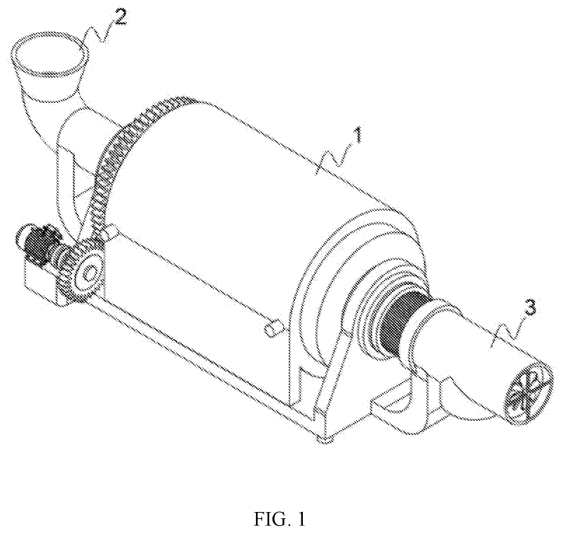

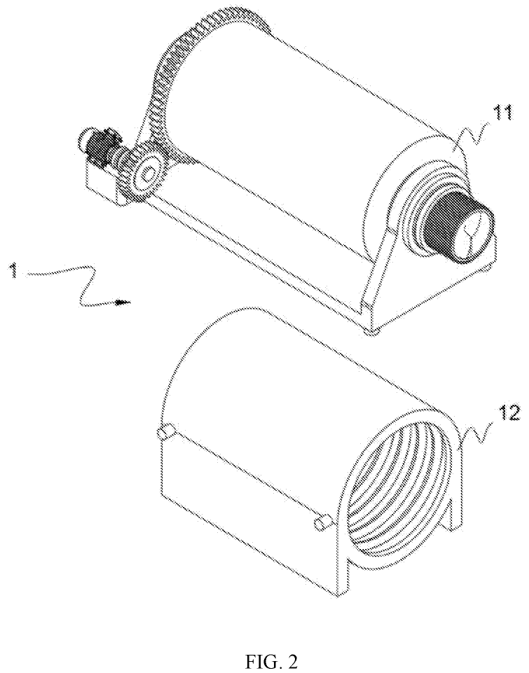

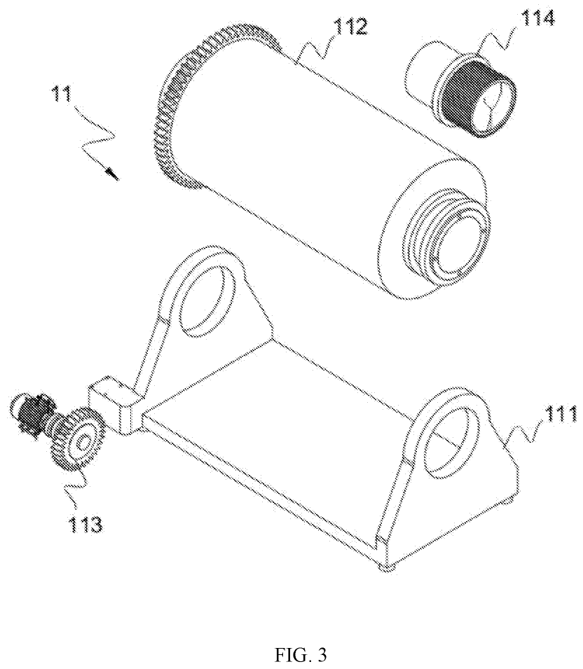

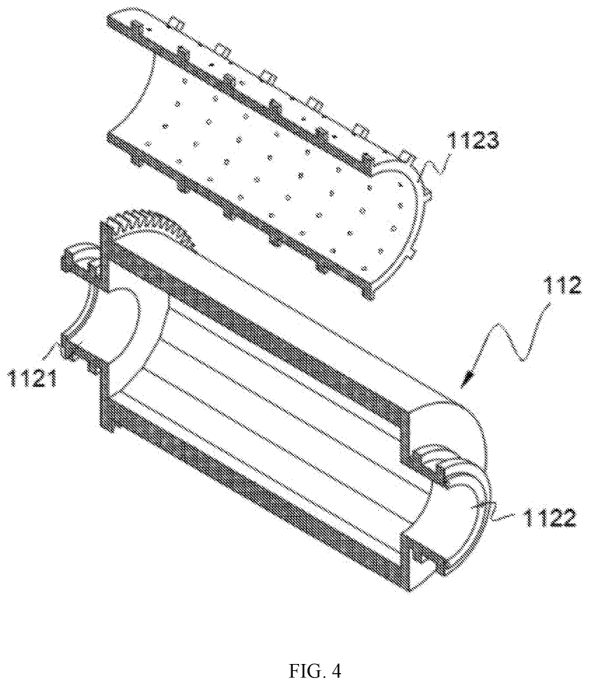

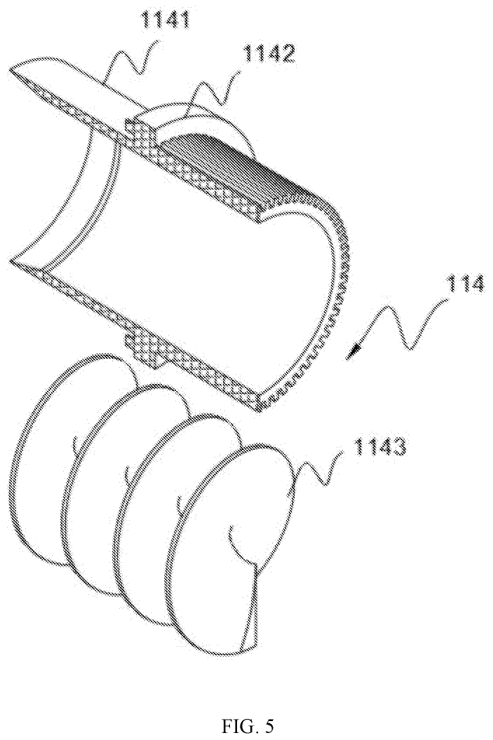

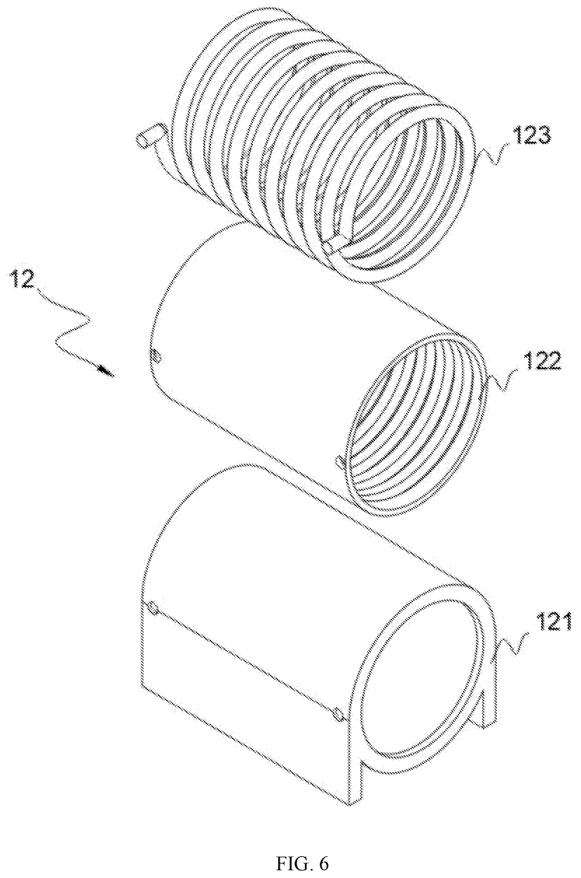

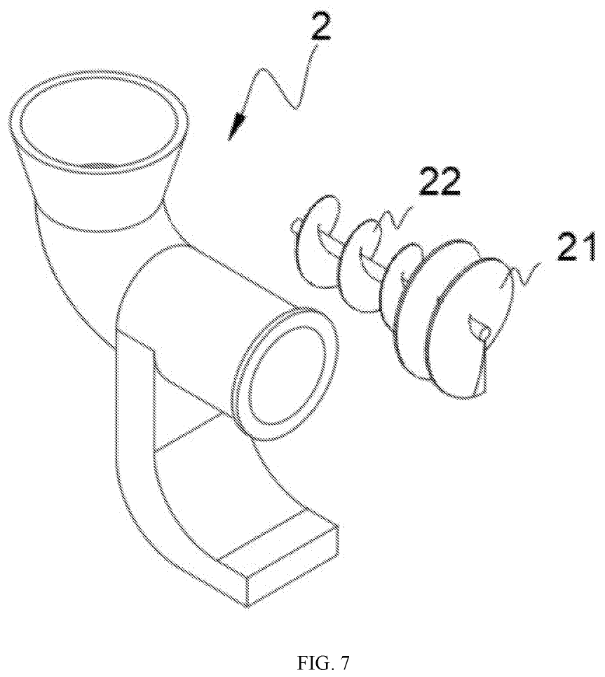

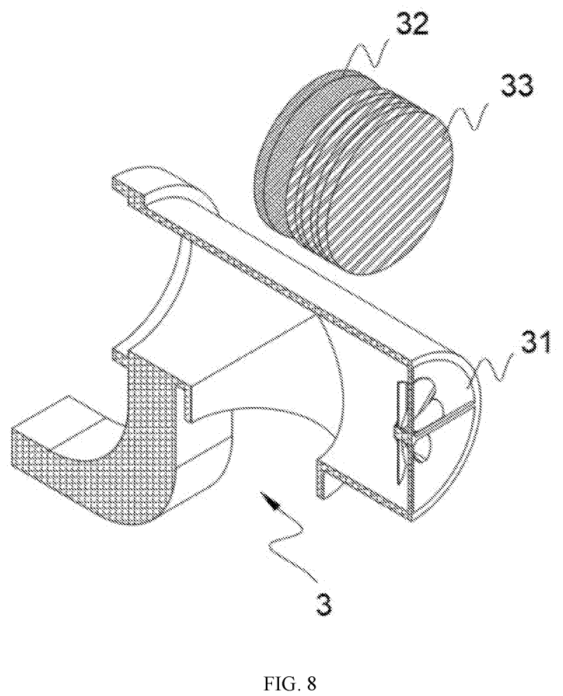

Please refer to FIG. 1 to FIG. 8, the objective of this embodiment is to provide a processing apparatus for removing dioxin in fly ash from domestic waste incineration by using a ball mill, including a grinder 1 as well as a feeding body 2 and a discharging body 3 that are separately arranged at both ends of the grinder 1, where the grinder 1 includes a removing body 11 and a heating body 12 arranged on a surface of the removing body 11, the removing body 11 includes a workbench 111 and a grinding cylinder 112 rotationally connected with both ends of a top of the workbench 111, a drive body 113 is arranged on one side of one end of the workbench 111, meshes with a gear on a surface of the grinding cylinder 112, and is used for driving the grinding cylinder 112 to rotate, the grinding cylinder 112 is located in the heating body 12 that is used for heating the grinding cylinder 112, making a grinding ball in the grinding cylinder 112 heat up, both ends of the grinding cylinder 112 communicate with a feeding port 1121 and a discharging port 1122 respectively, the feeding body 2 includes a first bracket and a hopper arranged at a top of the first bracket, the first bracket is connected with one end of the workbench 111, the hopper communicates with one end of the feeding port 1121 that is away from the grinding cylinder 112, the feeding body 2 is used for putting the fly ash from the domestic waste incineration into the grinding cylinder 112, a cooling body 114 is arranged in the discharging port 1122, the discharging body 3 includes a second bracket connected with the other end of the workbench 111, a dumping tube is arranged at a top of the second bracket and communicates with one end of the cooling body 114 that is away from the grinding cylinder 112, the cooling body 114 is used for lowering the temperature of an emission; and the discharging body 3 is used for discharging the processed fly ash from the domestic waste incineration.

During specific use of this embodiment, the fly ash from the domestic waste incineration is put from the hopper of the feeding body 2, the motor of the drive body 113 drives the drive gear through the coupling and then drives the meshed grinding cylinder 112 to rotate, the grinding cylinder 112 drives the third spiral plate 22 to rotate in the hopper through the second spiral plate 21 when rotating such that the fly ash from the domestic waste incineration, entering the bottom of the hopper, can be driven to be removed from the bottom of the hopper by the third spiral plate 22, and enters the heating body 12 along the second spiral plate 21; the induction coil 123 is electrified to generate an alternating magnetic field such that eddies generate on the inner wall of the grinding cylinder 112 in the induction coil 123, the grinding cylinder 112 is heated by the energy of these eddies, the fly ash from the domestic waste incineration and the grinding ball rotate in the inner cylinder 1123, when the fly ash from the domestic waste incineration is partially ground to powder through ball-milling, the powder can pass through the inner cylinder 1123 through the sieve pores and move in the space between the inner cylinder 1123 and the grinding cylinder 112, that is, only the fly ash from the domestic waste incineration, which is not yet ground into the powder, leaves in the inner cylinder 1123, such that the grinding ball can grind this part of fly ash from the domestic waste incineration, moreover the grinding ball can thermally desorb and decompose the harmful component, that is, dioxin in the fly ash through a high temperature when grinding the fly ash from the domestic waste incineration since the temperature in the grinding cylinder 112 reaches 300-500° C. during grinding, thus implementing the harmless treatment on the fly ash from the domestic waste incineration; after the fly ash from the domestic waste incineration in the grinding cylinder 112 is ground to powder, the heat is absorbed by the inner tube 1141 and radiated to the outside by the fins when the powder-like spills pass through the inner tube 1141, the fan drives the air in the discharging body 3 to flow, making the air in the cooling body 114 be discharged from the air filtering port 31, when the air wrapped with powder-like spills passes through the filter screen 32, the spills are intercepted by the filter screen 32, move down along the filter screen 32, enter the dumping port and are discharged, and when the air passes through the activated carbon plates 33, a trace amount of dioxin contained therein is absorbed by the activated carbon plates 33, thus ensuring to process the dioxin completely.

In this embodiment, to improve the processing efficiency for the fly ash from the domestic waste incineration, an inner cylinder 1123 is arranged in the grinding cylinder 112 and includes a cylinder and a plurality of connecting plates arranged on an outer wall of the cylinder, the cylinder is provided with a plurality of sieve pores penetrating through inner and outer walls thereof, and the connecting plates are connected with the inner wall of the grinding cylinder 112; and the inner cylinder 1123 is arranged such that the fly ash from the domestic waste incineration and the grinding ball rotate in the inner cylinder 1123, when the fly ash from the domestic waste incineration is partially ground to powder through ball-milling, the powder can pass through the inner cylinder 1123 through the sieve pores and move in the space between the inner cylinder 1123 and the grinding cylinder 112, that is, only the fly ash from the domestic waste incineration, which is not yet ground into the powder, leaves in the inner cylinder 1123, and the grinding ball can grind this part of fly ash from the domestic waste incineration, thus improving the processing efficiency for the fly ash from the domestic waste incineration.

For ease of heating the grinding cylinder 112, the heating body 12 includes a housing 121 and an induction coil 123 arranged in the housing 121, both ends of a bottom of the housing 121 are connected with an upper surface of the workbench 111, the grinding cylinder 112 is located in the induction coil 123, and a shielding cover 122 is arranged between the housing 121 and the induction coil 123; and the induction coil 123 is electrified by arranging the heating body 12 to generate an alternating magnetic field such that eddies generate on the inner wall of the grinding cylinder 112 in the induction coil 123, the grinding cylinder 112 is heated by the energy of these eddies, and the shielding cover 122 can shield an external electromagnetic interference, thus ensuring the heating effect to the grinding cylinder 112.

For ease of grinding the fly ash from the domestic waste incineration, the drive body 113 includes a motor arranged on one side of one end of the workbench 111, the motor is connected with a drive gear through a coupling, one end of the outer surface of the grinding cylinder 112 that is close to the motor is provided with a transmission gear, and the transmission gear meshes with the drive gear; and the drive body 113 is arranged such that the motor drives the drive gear through the coupling and then drives the meshed grinding cylinder 112 to rotate, making the grinding ball in the grinding cylinder 112 grind the fly ash from the domestic waste incineration.

Considering that the fly ash from the domestic waste incineration is not conductive to being collected due to a relatively high temperature thereof after the grinding is completed, to cool the fly ash from the domestic waste incineration, the cooling body 14 includes an inner tube 1141 located in the discharging port 1122, the other end of the inner tube 1141 communicates with the dumping tube, a snap ring 1142 is arranged in a middle of a surface of the inner tube 1141, a surface of one side of the snap spring 1142 that is close to the discharging port 1122 is symmetrically provided with a plurality of plugging shafts, a slot is correspondingly arranged on an outer surface of the discharging port 1122, the plugging shafts are located in the slot, the snap ring 1142 is in plugging fit with the discharging port 1122, and one end of an outer surface of the inner tube 1141 that is away from the discharging port 1122 is provided with a plurality of fins; and when the fly ash from the domestic waste incineration in the grinding cylinder 112 is ground to powder and the powder-like spills pass through the inner tube 1141, the heat is absorbed by the inner tube 1141 and radiated to the outside from the fins by arranging the cooling body 114, thus reducing the temperature for ease of collection.

For ease of movement of the fly ash from the domestic waste incineration at the feeding port 1121 and the discharging port 1122, a second spiral plate 21 is arranged in the feeding port 1121 and a first spiral plate 1143 is arranged in the inner tube 1141, when the heating body 12 rotates, the fly ash from the domestic waste incineration at the feeding port 1121 enters the heating body 12 along a spiral structure of the second spiral plate 21 by arranging the second spiral plate 21 and the first spiral plate 1143, and the powder-like spills, of which the grinding is completed, can move along the spiral structure of the first spiral plate 1143, enter the inner tube 1141, and are discharged from the dumping tube after being cooled.

Considering that the high sticky and easy caking of the fly ash from the domestic waste incineration lead to the easy blocking in the hopper, a middle of one end of the second spiral plate 21 that is away from the heating body 12 is connected with a third spiral plate 22, and the third spiral plate 22 is located at a bottom inside the hopper; and when the heating body 12 rotates, the second spiral plate 21 drives the third spiral plate 22 to rotate in the hopper by arranging the third spiral plate 22 in the hopper, such that the fly ash from the domestic waste incineration, entering the bottom of the hopper, can be driven to be removed from the bottom of the hopper by the third spiral plate 22, and enters the heating body 12 along the second spiral plate 21, thus avoiding the hopper blocking and ensuring the processing effect.

To ensure to process the dioxin completely, one end of the dumping tube that is away from the heating body 12 is provided with an air filtering port 31, a dumping port is arranged at a bottom of a middle of the dumping tube, a filter screen 32 is arranged at a place in the air filtering port 31 that is close to the dumping port, a plurality of activated carbon plates 33 are arranged in the air filtering port 31, a fan is arranged closely to the outside in the air filtering port 31, and the activated carbon plates 33 are located between the fan and the filter screen 32; and the fan drives the air in the discharging body 3 to flow by arranging the air filtering port 31, such that the air in the cooling body 114 is discharged from the air filtering port 31, when the air wrapped with powder-like spills passes through the filter screen 32, the spills are intercepted by the filter screen 32, move down along the filter screen 32, enter the dumping port and are discharged, and when the air passes through the activated carbon plates 33, a trace amount of dioxin contained therein is absorbed by the activated carbon plates 33, thus ensuring to process the dioxin completely.

To improve the cooling and heat dissipation efficiency of the inner tube 1141, one side of the discharging body 3 that is close to the inner tube 1141 is provided with an extensional side, and one side of the inner tube 1141 that is close to the discharging body 3 is partially located in the extensional side; and the inner tube 1141 is partially wrapped by arranging the extensional side, when the fan in the air filtering port 31 drives the air to be discharged from the air filtering port 31, the air located at a periphery of the inner tube 1141 is absorbed in the discharging body 3 from a gap between the inner tube 1141 and the extensional side, thus accelerating an air velocity at the fins of the inner tube 1141 and improving the cooling and heat dissipation efficiency of the inner tube 1141.

The basic principles, main characteristics and advantages of the present disclosure are shown and described above. Those skilled in the art shall understand that the present disclosure is not limited by the above embodiments, the above embodiments and specification describe the preferred embodiments of the present disclosure merely, are not intended to limit the present disclosure. Various changes and improvements will be made without deviating from the spirit and scope of the present the disclosure, and all of these fall within the protection scope of the present disclosure. The protection scope of the present disclosure is defined by the appended claims and their equivalents.

What is claimed is:

1. A processing apparatus for removing dioxin in fly ash from domestic waste incineration by using a ball mill, comprising a grinder, a feeding body and a discharging body, the feeding body and the discharging body being separately arranged at both ends of the grinder, wherein
the grinder comprises a removing body and a heating body arranged on a surface of the removing body, the removing body comprises a workbench and a grinding cylinder rotationally connected with both ends of a top of the workbench, a drive body is arranged on one side of one end of the workbench, meshes with a gear on a surface of the grinding cylinder, and is used for driving the grinding cylinder to rotate, the grinding cylinder is located in the heating body that is used for heating the grinding cylinder, both ends of the grinding cylinder communicate with a feeding port and a discharging port respectively;
the feeding body comprises a first bracket and a hopper arranged at a top of the first bracket, the first bracket is connected with one end of the workbench, the hopper communicates with one end of the feeding port that is away from the grinding cylinder, the feeding body is used for putting the fly ash from the domestic waste incineration into the grinding cylinder, a cooling body is arranged in the discharging port;
the discharging body comprises a second bracket connected with the other end of the workbench, a dumping tube is arranged at a top of the second bracket and communicates with one end of the cooling body that is away from the grinding cylinder, and the discharging body is used for discharging the processed fly ash from the domestic waste incineration;
the heating body comprises a housing and an induction coil arranged in the housing, both ends of a bottom of the housing are connected with an upper surface of the workbench, the grinding cylinder is located in the induction coil, and a shielding cover is arranged between the housing and the induction coil;
the cooling body comprises an inner tube located in the discharging port, the other end of the inner tube communicates with the dumping tube, a snap ring is arranged in a middle of a surface of the inner tube and in plugging fit with the discharging port, and one end of an outer surface of the inner tube that is away from the discharging port is provided with a plurality of fins;
one end of the dumping tube that is away from the heating body is provided with an air filtering port, a dumping port is arranged at a bottom of a middle of the dumping tube, a filter screen is arranged at a place in the air filtering port that is close to the dumping port, a plurality of activated carbon plates are arranged in the air filtering port, a fan is arranged closely to the outside in the air filtering port, and the activated carbon plates are located between the fan and the filter screen; and
one side of the discharging body that is close to the inner tube is provided with an extensional side, and one side of the inner tube that is close to the discharging body is partially located in the extensional side.

2. The processing apparatus for removing dioxin in fly ash from domestic waste incineration by using the ball mill according to claim 1, wherein an inner cylinder is arranged in the grinding cylinder and comprises a cylinder and a plurality of connecting plates arranged on an outer wall of the cylinder, the cylinder is provided with a plurality of sieve pores penetrating through inner and outer walls thereof, and the connecting plates are connected with the inner wall of the grinding cylinder.

3. The processing apparatus for removing dioxin in fly ash from domestic waste incineration by using the ball mill according to claim 1, wherein the drive body comprises a motor arranged on one side of one end of the workbench, the motor is connected with a drive gear through a coupling, one end of the outer surface of the grinding cylinder that is close to the motor is provided with a transmission gear, and the transmission gear meshes with the drive gear.

4. The processing apparatus for removing dioxin in fly ash from domestic waste incineration by using the ball mill according to claim 1, wherein a second spiral plate is arranged in the feeding port, and a first spiral plate is arranged in the inner tube.

5. The processing apparatus for removing dioxin in fly ash from domestic waste incineration by using the ball mill according to claim 4, wherein a middle of one end of the second spiral plate that is away from the heating body is connected with a third spiral plate, and the third spiral plate is located at a bottom inside the hopper.
